(19) United States
(12) Patent Application Publication
(10) Pub. No.: US 2009/0046066 A1
(43) Pub. Date: Feb. 19, 2009

(54) OPERATING DEVICE FOR OPERATING A MACHINE TOOL, A PRODUCTION MACHINE AND/OR A MACHINE IN THE FORM OF A ROBOT

(75) Inventors: RALF FRIEDRICH, Herzogenaurach (DE); Klaus Hertinger, Erlangen (DE); Uwe Scheuermann, Nurnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/189,463

(22) Filed: Aug. 11, 2008

(30) Foreign Application Priority Data
Aug. 9, 2007 (EP) EP07015724

(51) Int. Cl. G06F 3/02

(52) U.S. Cl. 345/168

(57) ABSTRACT

An operating device for operating a machine tool, a production machine and/or a machine in the form of a robot, includes a screen which is able to simultaneously display a first operating window and a second operating window. A first application for operating the machine can be displayed in the first operating window, and a second application for operating the machine can be displayed in the second operating window. The first application is operated using first operating buttons which are associated with the first operating window, and the second application is operated using second operating buttons which are associated with the second operating window. The first operating buttons are arranged along an individual side or a plurality of sides of the first operating window, and the second operating buttons are arranged along an individual side or a plurality of sides of the second operating window.

### CROSS-REFERENCES TO RELATED APPLICATIONS

This application claims the priority of European Patent Application, Serial No. EP 07015724, filed Aug. 9, 2007, pursuant to 35 U.S.C. 119(a)-(d), the content of which is incorporated herein by reference in its entirety as if fully set forth herein.

### BACKGROUND OF THE INVENTION

The present invention relates to an operating device for operating a machine tool, a production machine and/or a machine in the form of a robot

Nothing in the following discussion of the state of the art is to be construed as an admission of prior art.

In the case of operating devices for operating machine tools, production machines and/or robots, the machine is typically operated using a screen and a keyboard. The available space on the screen and the operating concepts which are customarily used nowadays result in information and operating sequences being structured using operating menus which are organized more or less logically. This means that, in the case of complex operating processes, the operator often has to switch back and forth between different operating windows, which are displayed in succession by the screen when a button is pressed and respectively take up virtually the entire screen, in the case of commercially available operating devices and the operator consequently sees only part of the required information in each case. It is necessary to frequently switch back and forth between different operating windows in commercially available machines, in particular in the case of operating processes which simultaneously require the information and/or operation of different machine components.

It would therefore be desirable and advantageous to address these problems and to obviate other prior art shortcomings

### SUMMARY OF THE INVENTION

According to one aspect of the present invention, an operating device for operating a machine such as a machine tool, production machine and/or machine in the form of a robot includes a screen having first and second operating windows to simultaneously display first and second applications for operating the machine, first operating buttons arranged at least along one side of the first operating window and permanently associated with the first operating window for operating the first application, and second operating buttons arranged at least along one side of the second operating window and permanently associated with the second operating window for operating the second application.

According to another feature of the present invention, the screen may have third and fourth operating windows to simultaneously display third and fourth applications for operating the machine, and further includes third operating buttons arranged at least along one side of the third operating window and permanently associated with the third operating window for operating the third application, and fourth operating buttons arranged at least along one side of the fourth operating window and permanently associated with the fourth operating window for operating the fourth application. As a result, four applications can be clearly operated.

According to another feature of the present invention, common fifth operating buttons may be provided for operating the machine, with one of the operating windows configured for association to the fifth operating buttons. Thus, the operating device can have permanently associated operating buttons as well as so-called common operating buttons which can be associated with a selected operating window, using a selection pushbutton, for example.

According to another feature of the present invention, the screen may be a touch-sensitive screen, with at least one of the first, second, third and fourth operating buttons being an integral part of the touch-sensitive screen. As a result, the need for conventional mechanical buttons can be eliminated or at least reduced so as to enable a simpler design of the operating device. It is, of course, also possible to provide the selection pushbutton and the common operating buttons as an integral part of the screen. The provision of a touch-sensitive screen enables quick and direct selection of the operating window, for example by pressing the operating window to be selected.

According to another feature of the present invention, the operating buttons may bee arranged outside the screen. In this way, the operating buttons can be made of particularly stable design. Furthermore, an ergonomic design of the operating buttons and/or a design of the operating buttons with tactility (tactile feedback to the operator) is/are enabled.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic illustration of a first embodiment of an operating device according to the invention; and

FIG. 2 shows a schematic illustration of a second embodiment of an operating device according to the invention.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

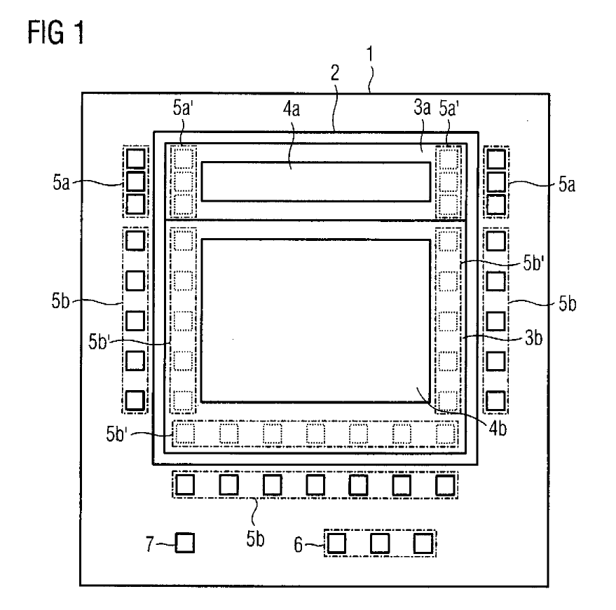

Turning now to the drawing, and in particular to FIG. 1, there is shown a schematic illustration of a first embodiment of an operating device according to the invention. The operating device 1 has a screen 2, the screen 2 simultaneously displaying a first operating window 3a and a second operating window 3b. A first application 4a for operating the machine is displayed in the first operating window 3a and a second application 4b for operating the machine is simultaneously displayed in the second operating window 3b. The first application 4a may be, for example, in the form of applications of, for example, the machine manufacturer, for example may represent functions with regard to the supply of coolant to the machine or chip delivery. The operator can then use the first application to parameterize, for example, the parameters needed for this purpose. The second application 4b may include, for example, the operation of control functionalities of the machining process. For example, the operator can use the second application 4b to input control parameters (for example the speed of rotation of a tool) for control, for example for machining a workpiece. The second application 4b may be present in such a way, for example in the form of a user interface for the control functionalities.

The first application 4a is operated using first operating buttons 5a which are associated with the first operating window 3a and the second application 4b is operated using second operating buttons 5b which are associated with the second operating window 3b. In this case, within the scope of the exemplary embodiment, the first operating buttons 5a and the second operating buttons 5b are arranged along a plurality of sides of the second operating window 3b. In this case, the individual operating buttons are diagrammatically illustrated in FIG. 1 in the form of small square boxes. The operator can operate the machine in a simple and clear manner by virtue of the permanent association of the operating buttons along an individual side or a plurality of sides of a respectively associated operating window. Furthermore, the operator can operate and see both the first application 4a and the second application 4b inside one screen display without said applications having to be called up only in succession with the aid of a menu, for example, as is customary in commercially available machines.

In this case, in FIG. 1, the first operating buttons 5a are arranged along the left-hand and right-hand sides of the first operating window 3a and the second operating buttons 5b are arranged along three sides of the second operating window 3b. It goes without saying that it is also conceivable for the operating buttons to be arranged only on an individual side of an operating window. This depends on the number of operating buttons required for the respective application. FIG. 1 illustrates an embodiment of the invention in which two applications are operated. However, it goes without saying that it is also possible to display even more applications (for example three, four, five, six etc.) in a manner analogous to the diagram shown in FIG. 1.

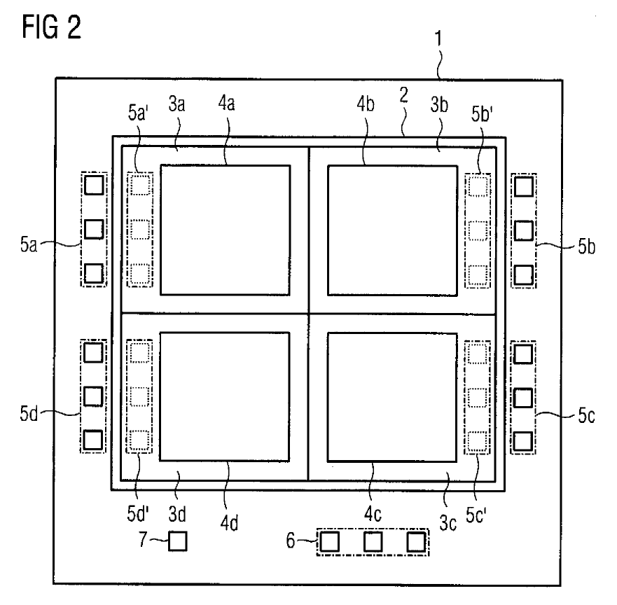

In this respect, FIG. 2 illustrates, by way of example, an embodiment of the invention in which four applications are simultaneously displayed, the same elements being provided, in FIG. 2, with the same reference symbols as in FIG. 1.

In this case, the screen 2 of the operating device 1 simultaneously displays a first operating window 3a, a second operating window 3b, a third operating window 3c and a fourth operating window 3d, a first application 4a for operating the machine being displayed in the first operating window 3a, a second application 4b for operating the machine being displayed in the second operating window 3b, a third application 4c for operating the machine being displayed in the third operating window 3c, a fourth application 4d for operating the machine being displayed in the fourth operating window 3d, the first application 4a being operated using first operating buttons 5a which are associated with the first operating window 3a, the second application 4b being operated using second operating buttons 5b which are associated with the second operating window 3b, the third application 4c being operated using third operating buttons 5c which are associated with the third operating window 3c, the fourth application 4d being operated using fourth operating buttons 5d which are associated with the fourth operating window 3d, the first operating buttons 5a being arranged along an individual side of the first operating window 3a, the second operating buttons 5b being arranged along an individual side of the second operating window 3b, the third operating buttons 5c being arranged along an individual side of the third operating window 3c, the fourth operating buttons 5d being arranged along an individual side of the fourth operating window 3d.

However, it goes without saying that the respective operating buttons may also be arranged along a plurality of sides of the respectively associated operating window, depending on the number of operating buttons required.

In the embodiment of the invention according to FIG. 1, the screen 2 is divided into two parts by virtue of the display of the operating windows on the screen, whereas, in the embodiment according to FIG. 2, the screen 2 is divided into four parts in accordance with the four operating windows. The screen 2 may be divided in this way according to the number of operating windows.

In addition to the operating buttons which are permanently associated with the respective operating window and have already been described, the operating device may also have so-called common operating buttons 6, which can be associated with one of the existing operating windows using a selection pushbutton 7, which is illustrated in FIG. 1 and FIG. 2. For this purpose, the selection pushbutton 7 is pressed briefly several times, for example, another operating window lighting up to a greater extent after each pressing operation and in this way signaling that the operating window in question, and so the application displayed in the operating window, has been selected. The application selected in such a way can then be operated using the common operating buttons 6. The operating buttons 6 can be used, for example, to input parameters. The selection pushbutton 7 may also be an integral part of a computer mouse.

The screen 2 may also be in the form of a touch-sensitive screen (touchscreen), the operating buttons or some of the operating buttons then being able to be an integral part of the screen. FIG. 1 and FIG. 2 illustrate corresponding operating buttons 5a′, 5b′, 5c′ and 5d′ which may be present as an alternative or in addition to the operating buttons 5a, 5b, 5c and 5d which are arranged outside the screen 2. Furthermore, it shall be noted at this juncture that the selection pushbutton 7 and the common operating buttons 6 may also be an integral part of the screen.

It goes without saying that the operating device may have not only an individual screen but also a plurality of screens with operating buttons, in which case, as far as the screens are concerned, applications are operated and displayed in an analogous form in accordance with the invention. It shall be noted at this juncture that it goes without saying that, in the case of an operating device having a plurality of screens, only one individual application can also be displayed by each screen.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An operating device for operating a machine, comprising:
a screen having first and second operating windows to simultaneously display first and second applications for operating the machine;
first operating buttons arranged at least along one side of the first operating window and permanently associated with the first operating window for operating the first application; and
second operating buttons arranged at least along one side of the second operating window and permanently associated with the second operating window for operating the second application.

2. The operating device of claim 1, wherein the machine is a machine tool, a production machine or a machine in the form of a robot.

3. The operating device of claim 1, wherein the screen has third and fourth operating windows to simultaneously display third and fourth applications for operating the machine, and further comprising third operating buttons arranged at least along one side of the third operating window and permanently associated with the third operating window for operating the third application, and fourth operating buttons arranged at least along one side of the fourth operating window and permanently associated with the fourth operating window for operating the fourth application.

4. The operating device of claim 1, further comprising common fifth operating buttons for operating the machine, with a selected one of the operating windows being associated with the fifth operating buttons.

5. The operating device of claim 4, further comprising a selection pushbutton for selecting the one of the operating windows.

6. The operating device of claim 3, wherein the screen is a touch-sensitive screen, at least one of the first, second, third and fourth operating buttons being an integral part of the touch-sensitive screen.

7. The operating device of claim 5, wherein the screen is a touch-sensitive screen, said fifth operating buttons and said selection pushbutton being an integral part of the touch-sensitive screen.

8. The operating device of claim 1, wherein the operating buttons are arranged outside the screen.

9. A machine, comprising an operating device including a screen having first and second operating windows to simultaneously display first and second applications for operating the machine, first operating buttons arranged at least along one side of the first operating window and permanently associated with the first operating window for operating the first application, and second operating buttons arranged at least along one side of the second operating window and permanently associated with the second operating window for operating the second application.

10. The machine of claim 9, constructed in the form of a machine tool, a production machine or a robot.
